(19) United States
(12) Patent Application Publication
(10) Pub. No.: US 2026/0338569 A1
(43) Pub. Date: Oct. 29, 2026

(54) MAP DISPLAY BASED ON LOCATION CLUSTERS FROM HISTORICAL GRAPHICAL USER INTERFACE (GUI) INTERACTION DATA

(71) Applicant: HERE GLOBAL B.V., EINDHOVEN (NL)

(72) Inventor: Robin Kim, Naperville, IL (US)

(73) Assignee: HERE GLOBAL B.V., EINDHOVEN (NL)

(21) Appl. No.: 19/089,038

(22) Filed: Mar. 25, 2025

(51) Int. Cl. G01C 21/36

(52) U.S. Cl. CPC G01C 21/3617; G01C 21/367

(57) ABSTRACT

A system, method, apparatus, etc., for retrieving or receiving historical graphical user interface (GUI) interaction data based on a received search query from a first user. The search query includes a request for map data of a geographical region. A cluster is determined for at least one location in the geographical region based on the historical GUI interaction data and the search query. The rendering of the map data is controlled on a map user-interface (UI), based on the at least one location of the cluster.

### TECHNOLOGICAL FIELD

An example embodiment relates generally to a method, apparatus, computer readable storage medium, user interface and/or computer program product for map display based on location clusters, and more particularly, map display based on location clusters from historical graphical user interface (GUI) interaction data.

### BACKGROUND

The advancements of digital map searching systems have led to extensive use of maps for navigation, locating places, finding nearby amenities, and geospatial analysis. The digital map searching systems allow users to input queries to find specific addresses or locations on digital maps, featuring interactive capabilities like zooming, panning, and accessing detailed information about points of interest. However, these systems often face challenges in accurately displaying relevant results due to insufficient contextual consideration, leading to imprecise outcomes. Users may receive broad and nonspecific results, requiring them to sift through large areas to find their point of interest (POI). When queries cover larger regions, the system may generate numerous POIs, making the process time-consuming and tedious, ultimately diminishing the user experience.

### BRIEF SUMMARY

A method, apparatus, computer readable storage medium, user interface, and computer program product are provided in accordance with an example embodiment for map display based on location clusters from historical graphical user interface (GUI) interaction data.

In this regard, the method, apparatus, computer readable storage medium, and computer program product of an example embodiment may be an apparatus, the apparatus comprising at least one processor and at least one memory storing computer program code, the at least one memory and the computer program code configured to, with the processor, cause the apparatus to at least: receive a search query including a request for map data of a geographical region; and receive, based on the search query, historical graphical user interface (GUI) interaction data related to at least one location in the geographical region. Further, the apparatus may determine a cluster for the at least one location in the geographical region based on the historical GUI interaction data; and control rendering of the map data on a map user-interface (UI), based on the at least one location of the cluster.

In yet another embodiment, the historical GUI interaction data includes a number of user interactions with the GUI for the at least one location, and the cluster is determined based at least in part on the number of user interactions included in the historical GUI interaction data.

In yet another embodiment, the historical GUI interaction data includes an end point for one or more end user session related to the user interaction with the GUI for the at least one location.

In yet another embodiment, the geographical region includes at least one of: a road segment, a building, a monument, a tourist site, an educational campus, a recreational area, an agricultural field, a park, a market area, a shopping complex, a residential area, an office complex, a farm-land, a county, a town, a city, a state, or a country.

In yet another embodiment, the search query corresponds to a user-input including at least one of: a natural-language text, a natural-language audio, or a user-interaction with the map UI.

In yet another embodiment, the search query is received from a first user and the historical GUI interaction data is received from a second user.

In yet another embodiment, the apparatus may store the historical GUI interaction data on a search history database. The historical GUI interaction data may be received from the search history database.

In yet another embodiment, the apparatus may apply an artificial intelligence (AI) model on the historical GUI interaction data; and determine the cluster for the at least one location based on the application of the AI model on the historical GUI interaction data.

In yet another embodiment, the AI model corresponds to a clustering model including one of: a self-supervised learning model, a semi-supervised learning model, or an un-supervised learning model.

In yet another embodiment, the controlling the rendering of the map data includes displaying an indication of an enlarged view of the at least one location of the cluster on the map UI.

In yet another embodiment, the apparatus may determine a centroid position of the cluster. The enlarged view of the at least one location of the cluster is centered at the centroid position of the cluster on the map UI.

All this information/feedback may be displayed on an end user device (e.g., smartphone, tablet, etc.) and/or in a motor vehicle (e.g., upon a built-in vehicle display).

In other embodiments, a UI may be provided which displays in real-time the map data on a map user-interface (UI), based on the at least one location of the cluster. Further, users may also manually select a cluster from a set of clusters to be displayed on the map UI. The users may also select the cluster based on density of the location or on user’s preferences.

Also, a computer program product may be provided. For example, a computer program product comprising instructions which, when the program is executed by a computer, cause the computer to carry out the steps described herein.

In yet another aspect, disclosed is an apparatus and/or non-transitory computer readable medium having stored thereon instructions executable by processor(s) to cause an apparatus to perform operations described herein, such as any of those set forth in the disclosed method(s), among others.

In yet another aspect, disclosed is a computer program product including instructions which, when the program is executed by a computer, cause the computer to carry out the steps described herein, such as any of those set forth in the disclosed method(s). In other words, the computer program product may have computer-executable program code portions stored therein, the computer-executable program code portions including program code instructions configured to perform any operations set forth in any of the method(s) disclosed herein, among others.

These as well as other features and advantages of the invention will become apparent from the following detailed description considered in conjunction with the accompanying drawings where appropriate. It should be understood, however, that the drawings are designed solely for the purposes of illustration and not as a definition of the limits of the present disclosure. It should be further understood that the drawings are not drawn to scale and that they are merely intended to conceptually illustrate one or more of the features described herein. None of the examples shown or discussed herein are limiting on any aspect of the claimed subject matter.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a database of an example embodiment of the apparatus;

FIG. 3 is a flowchart illustrating the operations performed, such as, by the apparatus of FIG. 1, in order to display map based on location clusters from historical graphical user interface (GUI) interaction data;

FIG. 4A is a graphical representation of a map display including a set of clusters; and

FIG. 4B is a graphical representation of a map display indicating a cluster with highest density based on historical GUI interaction data.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided as example embodiments for map display based on location clusters from historical graphical user interface (GUI) interaction data. In order to provide such a service, the system, the method, the apparatus, a non-transitory computer-readable storage medium, and the computer program product of an example embodiment may be configured to receive a search query including a request for map data of a geographical region; and receive, based on the search query, historical GUI interaction data related to at least one location in the geographical region. The service, the system, the method, the apparatus, a non-transitory computer-readable storage medium, and the computer program product may be further configured to determine a cluster for the at least one location in the geographical region based on the historical GUI interaction data; and control rendering of the map data on a map user-interface (UI), based on the at least one location of the cluster. The historical GUI interaction data may include information related to direct or indirect end user interaction with a GUI for the at least one location. Further, the historical GUI interaction data may include a number of user interactions with the GUI for the at least one location and may also include an end point for an end user session related to the user interaction with the GUI for the at least one location. In an embodiment, the end point for the user session related to the user interaction may be a last destination/ endpoint location searched by a user in the given user session, which may be tracked/stored in the historical GUI interaction data. The cluster may be determined based at least in part on the number of user interactions included in the historical GUI interaction data.

Further, the service, the system, the method, the apparatus, a non-transitory computer-readable storage medium, and the computer program product may be further configured to store the historical GUI interaction data on a search history database and apply an artificial intelligence (AI) model to determine the cluster for the at least one location. The AI model corresponds to a clustering model including one of a self-supervised learning model, a semi-supervised learning model, or an un-supervised learning model. The service, the system, the method, the apparatus, a non-transitory computer-readable storage medium, and the computer program product may be further configured to control the rendering of the map data includes displaying an indication of an enlarged view of the at least one location of the cluster on the map UI. Further, the apparatus may determine a centroid position of the cluster such that enlarged view of the at least one location of the cluster is centered at the centroid position of the cluster on the map UI.

In some embodiments, the location of the geographical region is determined based on at least one of Global Positioning System (GPS) data, Global Navigation Satellite System (GNSS) data, or vehicle sensor data.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to display the map display based on location clusters from the historical GUI interaction data may similarly be embodied by the same or different server, computer workstation, distributed network of computing devices, personal computer, or other type of computing device.

Alternatively, the system, etc. may be embodied by a computing device on board, such as a computer system, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system, a control system of a vehicle including but not limited to various automated vehicle controls, an electronic control unit of a vehicle, an autonomous vehicle control system (e.g., a semi or fully autonomous-driving control system) of a vehicle, a mapping system of a vehicle, an Advanced Driver Assistance System (ADAS) of a vehicle), or any other type of computing device. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

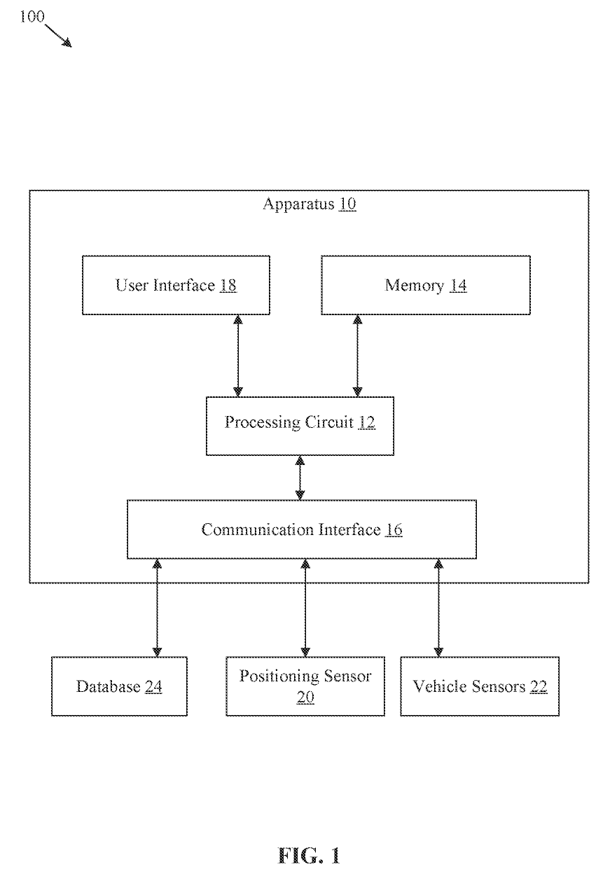

Regardless of the manner in which the system, apparatus, etc. is embodied, however, an apparatus 10 includes, is associated with, or is in communication with processing circuit 12, memory 14, a communication interface 16 and optionally a user interface 18 as shown in FIG. 1. In some embodiments, the processing circuit 12 (and/or co-processors or any other processors assisting or otherwise associated with the processing circuitry) can be in communication with the memory 14 via a bus for passing information among components of the apparatus. The memory 14 can be non-transitory and can include, for example, one or more volatile and/or non-volatile memories. In other words, for example, the memory 14 may be an electronic storage device (for example, a computer readable storage medium) comprising gates configured to store data (for example, bits) that can be retrievable by a machine (for example, a computing device like the processing circuitry). The memory 14 can be configured to store information, data, content, applications, instructions, or the like for enabling the apparatus to carry out various functions in accordance with an example embodiment of the present disclosure. For example, the memory 14 can be configured to buffer input data for processing by the processing circuit 12. Additionally, or alternatively, the memory 14 can be configured to store instructions for execution by the processing circuit 12.

The apparatus 10 may be specifically configured in accordance with an example embodiment of the present invention for map display based on location clusters from historical GUI interaction data. The apparatus 10 may include or otherwise be in communication with the processing circuit 12, the memory 14, the communication interface 16 and optionally the user interface 18. Further, the communication interface 16 may interact with a positioning sensor 20, vehicle sensors 22, and a database 24. The apparatus 10 may be configured to receive a search query and historical GUI interaction data related to at least one location in the geographical region. Further, the apparatus 10 may determine a cluster for the at least one location in the geographical region based on the historical GUI interaction data, and control rendering of the map data on a map user-interface (UI), based on the at least one location of the cluster. As used herein, the term “search query” may also be known as query, that refers to a request for information that a user submits to a system or a database (such as the database 24). The search query may be a natural language text input, an audio, an image, etc. For example, the search query may include keywords, phrases, text, sentences or the like, that the user may input. Further, the system may process the search query based on algorithms such as geocoding algorithms and natural language processing algorithms. For example, the search query can be “nearest medical store” in a system provided by the user and the system may process the request to provide a search result. In context of the present disclosure, the term “search query” may be a request for map data of a geographical region provided by the user to the system. The system may process the search query associated with a location corresponding to the geographical region and provide a map display including a set of clusters associated with the location or a cluster of the set of clusters display in an enlarged view. Further, the search queries from a set of users may be stored in the database 24.

As used herein, the term “historical GUI interaction data” refers to a data that may be an information related to a user interaction with a GUI for the at least one location.

The processing circuit 12 may be embodied in a number of different ways. For example, the processing circuit 12 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuit 12 can include one or more processing cores configured to perform independently. A multi-core processor can enable multiprocessing within a single physical package. Additionally, or alternatively, the processing circuit 12 can include one or more processors configured in tandem via the bus to enable independent execution of instructions, pipelining and/or multithreading.

In an example embodiment, the processing circuit 12 may be configured to execute instructions stored in the memory 14 or otherwise accessible to the processing circuit 12. Alternatively, or additionally, the processing circuitry 12 may be configured to execute hard coded functionality. As such, whether configured by hardware or software methods, or by a combination thereof, the processing circuit 12 may represent an entity (for example, physically embodied in circuitry) capable of performing operations according to an embodiment of the present disclosure while configured accordingly. Thus, for example, when the processing circuit 12 may be embodied as an ASIC, FPGA or the like, the processing circuit 12 may be specifically configured hardware for conducting the operations described herein. Alternatively, as another example, when the processing circuit 12 may be embodied as an executor of software instructions, the instructions can specifically configure the processing circuit 12 to perform the algorithms and/or operations described herein when the instructions are executed. However, in some cases, the processing circuit 12 may be a processor of a specific device (for example, a computing device) configured to employ an embodiment of the present disclosure by further configuration of the processor by instructions for performing the algorithms and/or operations described herein. The processing circuit 12 can include, among other things, a clock, an arithmetic logic unit (ALU) and/or one or more logic gates configured to support operations of the processing circuit 12.

The apparatus 10 of an example embodiment may also include the memory 14 that may include suitable logic, circuitry, and/or interfaces that may be configured to store program instructions executable by the processing circuit 12. In certain embodiments, the memory 14 may be configured to store the search query, the historical GUI interaction data, the map data of the geographical region, and an artificial intelligence (AI) model. The memory 14 may include computer-readable storage media for carrying or having computer-executable instructions or data structures stored thereon. Such computer-readable storage media may include any available media that may be accessed by a general-purpose or special-purpose computer, such as the processing circuit 12.

By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processing circuit 12 to perform a certain operation or group of operations associated with the apparatus 10.

The apparatus 10 of an example embodiment may also include the communication interface 16 that may be any means such as a device or circuitry embodied in either hardware or a combination of hardware and software that is configured to receive and/or transmit data from/to other electronic devices in communication with the apparatus, such as, a database. Herein, the database in one embodiment, comprises the database 24 that may store data (e.g., the search query, the historical GUI interaction data, the map data of the geographical region, and the artificial intelligence (AI) model , etc.) generated and/or employed by the processing circuit 12. In an example, the database 24 may also store map data, such as, one or more map objects, point-of-interest (POI) data, etc. Additionally, or alternatively, the communication interface 16 may be configured to communicate in accordance with various wireless protocols including satellite communication systems (such as, through a network of low-earth orbit satellites), Global System for Mobile Communications (GSM), such as, but not limited to Long Term Evolution (LTE), 3G, 4G, 5G, 6G, etc. In this regard, the communication interface 16 may include, for example, an antenna (or multiple antennas) and supporting hardware and/or software for enabling communications with a wireless communication network. In this regard, the communication interface 16 may include, for example, an antenna (or multiple antennas) and supporting hardware and/or software for enabling communications with a wireless communication network. Additionally, or alternatively, the communication interface 16 may include the circuitry for interacting with the antenna(s) to cause transmission of signals via the antenna(s) or to handle receipt of signals received via the antenna(s). In some environments, the communication interface 16 may alternatively or also support wired communication and/or may alternatively support vehicle to vehicle or vehicle to infrastructure wireless links. The communication mediums may also be used to aid in position of a given end user, vehicle, and/or mobile device.

The apparatus 10 may also optionally include the user interface 18 that may, in turn, be in communication with the processing circuit 12 to provide output to the user and, in some embodiments, to receive an indication of a user input. As such, the user interface 18 may include a display and, in some embodiments, may also include a keyboard, a mouse, a joystick, a touch screen, touch areas, soft keys, one or more microphones, a plurality of speakers, or other input/output mechanisms. In one embodiment, the processing circuit 12 may comprise user interface circuitry configured to control at least some functions of one or more user interface elements such as a display and, in some embodiments, a plurality of speakers, a ringer, one or more microphones and/or the like. The processing circuit 12 and/or the user interface circuitry (such as, the user interface 18) embodied by the processing circuit 12 may be configured to control one or more functions of one or more user interface elements through computer program instructions (for example, software and/or firmware) stored on a memory accessible to the processing circuitry (for example, the memory 14, and/or the like).

The user interface 18 may include suitable logic, circuitry, and interfaces that may be configured to render a User Interface (UI) with option(s) to configure and submit a dataset (e.g., the historical GUI interaction data) that may be related to at least one location in the geographical region of map data. The user interface 18 may further display the map data on a map user-interface (UI), based on the at least one location of the cluster. The map data displayed includes an indication of an enlarged view of the at least one location of the cluster on the map UI. The user interface 18 may communicate with the apparatus 10 via a network interface. Examples of the user interface 18 may include, but are not limited to, a mobile device, a desktop computer, a laptop, a virtual machine, a computer workstation, or a server, such as a cloud server. Further, the user interface 18 may include a display device. Furthermore, the display device may include suitable logic, circuitry, and interfaces that may be configured to accept inputs associated with the user and render outputs generated by the apparatus 10. The display device of the user interface 18 may be a touch screen which may enable a user to provide user-inputs via the display device. The touch screen may be at least one of a resistive touch screen, a capacitive touch screen, or a thermal touch screen. The display device may be realized through several known technologies such as, but not limited to, a Liquid Crystal Display (LCD) display, a Light Emitting Diode (LED) display, a plasma display, or an Organic LED (OLED) display technology, or other display devices. In accordance with an embodiment, the display device may refer to a display screen of a head mounted device (HMD), a smart-glass device, a see-through display, a projection-based display, an electro-chromic display, or a transparent display.

In certain embodiments, the apparatus 10 can be equipped or associated with one or more positioning sensors (for example, the positioning sensor 20), such as, one or more GPS or GNSS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus 10 for use, such as, by the processing circuit 12, in navigation assistance and/or autonomous vehicle control, as described herein according to example embodiments.

In certain embodiments, the apparatus 10 may further be equipped with or in communication with one or more vehicle sensors (such as, the vehicle sensors 22). In some example embodiments, the vehicle sensors 22 can be implemented in a vehicle or other remote apparatuses. The vehicle sensors 22 may include systems which capture image data (via one or more cameras, etc.), audio data (via one or more microphones, etc.), video data (via one or more video recorders, etc.), infrared (IR) data (via an IR sensor), temperature data (via a temperature sensor), and/or speed data (via a speedometer of the vehicle or a speed camera installed on a road segment).

For example, the vehicle sensors 22 may be in-built in a vehicle or proximate to it (e.g., traffic cameras, security cameras, etc.). While embodiments may be implemented with a single camera such as a front facing camera in a consumer vehicle, other embodiments may include the use of multiple individual cameras at the same time. A helpful example is that of a vehicle driving down a road. Many modern cars have one or more cameras installed on them to enable automatic braking and other types of assisted or automated driving. Many cars also have rear facing cameras to assist with automated or manual parking. In one embodiment of the current system, apparatus 10, method, etc. the vehicle sensors 22 may be utilized to acquire vehicle sensor data based on capture of images and/or audio, temperature, speed of the user, vehicles, streets, etc. as an end user travels/moves around. The system, apparatus 10, etc. may acquire such vehicle sensor data (via the vehicle sensors 22) and analyze it along with other relevant data to determine a location of the user on a certain street, area, etc. It should be noted that various types of data such as end-user location data, vehicle data, visited location data, may be detected via any functional means.

The data captured concerning end-user location data may also come from traffic cameras, security cameras, or any other functionally useful source (e.g., historic data, satellite images, websites, NFC data, Wi-Fi positioning, etc.).

The analysis of the image data, audio data, and other relevant data concerning end user location, etc. may be carried out by a machine learning (ML) model or an artificial intelligence (AI) model. The ML model / AI model may utilize any functionally useful means of analysis to identify end-user location data on a given roadway, road segment, building, or in a general area. The system, in this embodiment, may also examine relevant proximate points of interest (POIs), map objects, road geometries, animate/inanimate objects, etc., which could suggest potential end-user location data / information.

The locations of the user, their vehicle, any relevant points of interest (POIs), and other types of data which are utilized by various embodiments of the apparatus may each be identified in terms of latitudes and longitudes based on a location of the end user and their vehicle. In an example, a GPS sensor may be used to identify the location of the end user’s device (e.g., smart phone, smart watch, tablet, etc.) and/or the end user vehicle (e.g., an EV, a truck, a car, a bus, etc.). The POIs, map objects, infrastructure, etc. identified by the system may also be detected via the vehicle sensors 22.

In certain embodiments, information detected by the one or more cameras or other sensors (of the vehicle sensors 22) may be transmitted to the apparatus 10, such as the processing circuit 12, as image data and/or audio data. The data transmitted by the one or more cameras, microphones, etc. can be transmitted via one or more wired communications and/or one or more wireless communications (e.g., near field communication, or the like). In some environments, the communication interface 16 can support wired communication and/or wireless communication with the vehicle sensors 22 (e.g., the one or more cameras, etc.).

The database 24 may be stored or cached on a device such as the apparatus 10 or any system. The database 24 may be a search history database, that may be hosted on multiple servers at the same or different locations. Operations of the database 24 may be executed using hardware including a processor, a microprocessor (e.g., to perform or control performance of one or more operations), a field-programmable gate array (FPGA), or an application-specific integrated circuit (ASIC). In some other instances, the database 24 may be implemented using software.

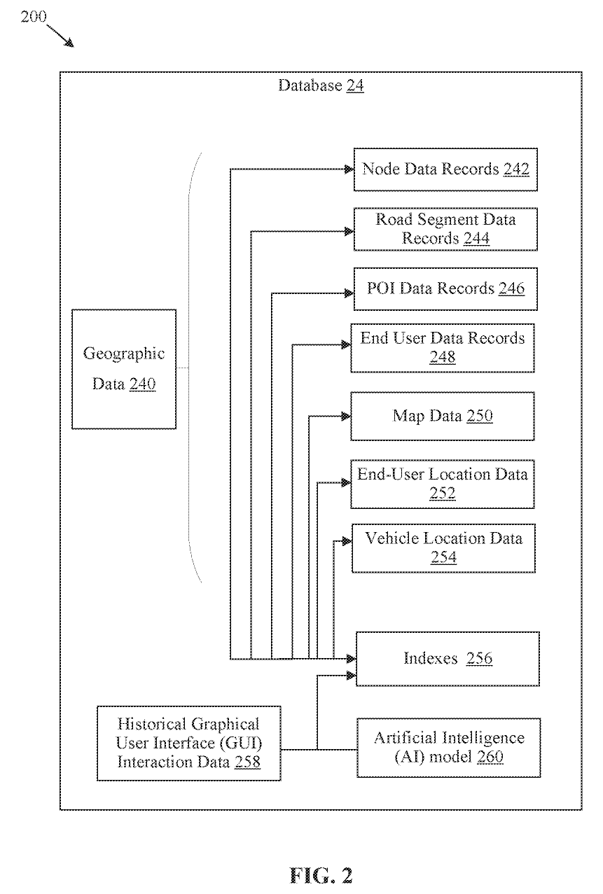

Turning to FIG. 2, the database 24 as shown in the exemplary scenario 200 may be a map or geographic or locational database that may include various types of geographic data 240. This geographic data 240 may include but is not limited to node data records 242, road segment data records 244, map object and point of interest (POI) data (also referred as POI data records 246), end user data records 248, map data 250, end-user location data 252 (location data for end users / clients), vehicle location data 254, indexes 256, etc. The other data records may include historical GUI interaction data 258, an artificial intelligence (AI) model 260, and the like. Additionally, the historical GUI interaction data 258 may also include information related to a number of user interactions with a GUI for the at least one location, etc. End user preference data may also be accounted for in one or more databases. For example, the end user preference data may include preferred location amongst a large area, etc. (such as a geographical region that includes at least one of: a road segment, a building, a monument, a tourist site, an educational campus, a recreational area, an agricultural field, a park, a market area, a shopping complex, a residential area, an office complex, a farm-land, a county, a town, a city, a state, or a country.)

In one embodiment, the following terminology applies to the representation of geographic features in the database 24. A “Node” – is a point that terminates a link, a “road/line segment” – is a straight line connecting two points., and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The database 24 may also include cartographic data, routing data, and/or maneuvering data as well as indexes 256. In an example, the indexes 256 may be look-up tables storing pointers to information (e.g., the geographic data 240 and the historical GUI interaction data 258) stored in the database 24. According to some example embodiments, the road segment data records 244 may be links or segments representing roads, streets, or paths, as may be used in calculating a route or recorded route information for determination of one or more personalized routes. The node data (for example, the node data records 242) may be end-points (e.g., intersections) corresponding to the respective links or segments of road segment data records 244. The road link data (for example, the road segment data records 244) and the node data (for example, the node data records 242) may represent a road network, such as used by vehicles, cars, trucks, buses, motorcycles, bikes, scooters, and/or other entities. Data may flow freely between the geographic data 240 and the indexes 256 as needed (or restricted as needed).

Optionally, the database 24 may include the road segment data records 244 and the node data records 242 or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as national park, shopping area, a building, a monument, a tourist site, an educational campus, a recreational area, an agricultural field, a park, a market area, a shopping complex, a residential area, an office complex, a farm-land, a county, a town, a city, a state, a country, hotels, museums, stadiums, offices, auto repair shops, buildings, stores, parks, etc. The database 24 can include data about the POIs and their respective locations in the POI data records 246. The database 24 may include data about places, such as cities, towns, or other communities, and other geographic features such as bodies of water, mountain ranges, etc. Such place or feature data can be part of the POI data records 246 or may be associated with POIs or POI data records 246 (such as a data point used for displaying or representing a position of a city). In addition, the database 24 can include event data (e.g., traffic incidents, construction activities, scheduled events, unscheduled events, etc.) associated with the POI data records 246 or other records of the database 24 (for example, a geographic database).

The database 24 may be maintained by a content provider, e.g., a map data service provider, and may be accessed, for example, by a content or service provider processing server. By way of example, the map data service provider can collect geographic data and dynamic data to generate and enhance the database 24 and dynamic data such as traffic-related data included therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through ML as described herein. However, the most ubiquitous form of data that may be available is vehicle data provided by vehicles, such as mobile device, as they travel the roads throughout a region.

The database 24 may be a master map database, such as a high definition (HD) map database, stored in a format that facilitates updates, maintenance, and development. For example, the database 24 may be a master database in which data can be stored in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, the geographic data 240 may be compiled (such as, into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by a mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

As mentioned above, the database 24 may be a master geographic database, but in alternate embodiments, a client-side database may represent a compiled navigation database that may be used in or with end user devices to provide navigation and/or map-related functions. For example, the database 24 may be used with the mobile device to provide an end user with navigation features. In such a case, the database 24 can be downloaded or stored on the end user device which can access the database 24 through a wireless or wired connection, such as via a processing server and/or a network, for example. It should be noted the database 24 may also include data regarding the interiors of buildings, homes, offices, area, country, region, etc. to aid the system, apparatus 10, etc. in tracking end user location as the end user moves around one location or between locations.

The end user data records 248 may include various points of data such as, but not limited to, the end-user location data 252 (at a first location, a second location, etc.), end user payment data, EV charging needs, density data, data associated with location that have high foot traffic, and preference data, end user driving profile data (e.g., driving tendencies, preferences, etc.), historical GUI interaction data 258, data concerning a user’s typical travel routine, and other end user data useful for determining a cluster for the at least one location in the geographical region. The manner by which the apparatus 10 records and stores data may vary, and the examples discussed herein are non-limiting. It should be noted that the end-user location data 252 may also be a separate record from the end user data records 248.

The end-user location data 252 may, in some embodiments, include data obtained from GNSS, GPS, NFC, Wi-Fi triangulation, cellular tower information, micro-mobility data, image data of the end user, radio map data, etc. It should be noted that throughout this disclosure, end-user location data may include location data of an end user and/or their end user device(s) or vehicle(s). In some situations, it may be more useful to track end user location generally or track specific location of an end user device or vehicle. For example, if an end user exits their vehicle at a POI location, it may be more useful to track the location of their vehicle than the location of the mobile phone. Such determination may be made in real time by the system in some embodiments.

The geographic data 240 may further include map data 250, which may be described as a collection of geographical location information. This information may represent the physical features, boundaries, and attributes of a specific area or region. The map data 250 may be used to create maps, that may be visual representations of geographic spaces. Further, the map data 250 also include topography, land use, transportation networks, political boundaries, and points of interest (POI) of the user. Further, the end-user location data 252 may be associated with the positioning of an end user. The end-user location data 252 may include a current geographical location of the end user. The location data of other end users may also be tracked in one or more embodiment, including a first end user, a second end user, a third end user, etc. The location data may, in some embodiments, include data obtained from GNSS, GPS, NFC, Wi-Fi triangulation, cellular tower information, micro-mobility data, image data of the end user, radio map data, etc. It should be noted that throughout this disclosure, end-user location data 252 may include location data of an end user and/or their end user device(s).

The geographic data 240 may also include the vehicle location data 254 that may be associated with the positioning of the vehicle associated with an end user. The Vehicle location data 254 may include a current geographical location of the vehicle. The location data of other vehicles (including a first vehicle, a second vehicle, third vehicle, etc.) may also be tracked in one or more embodiments. The location data may, in some embodiments, include data obtained from GNSS, GPS, NFC, Wi-Fi triangulation, cellular tower information, micro-mobility data, image data of the end user, radio map data, etc. It should be noted that throughout this disclosure, the vehicle location data 254 may include location data of the vehicle and/or the end user’s device(s) or vehicle(s) internal systems.

It should also be noted that the end-user location data 252 and the vehicle location data 254 may be same when the end user is driving the vehicle and may be different when the end user is at a distance or is away from their associated vehicle. Further, the vehicle location data 254 and the end-user location data 252 may be interchangeably used when the vehicle location data 254 and the end-user location data 252 are the same or within a small distance (e.g., 1 meter).

The database 24 may include the historical GUI interaction data 258 and the AI model 260. The historical GUI interaction data 258 may refer to information collected about user interaction with the GUI over time. The user interaction with the GUI may be for the at least one location of the geographical region. The user interaction may include navigation, preferences selection, or any other human activities on the GUI. In an example, the historical GUI interaction data 258 may include a number of user interactions with the GUI for the at least one location. The cluster of the at least one location may be determined based at least in part on the number of user interactions included in the historical GUI interaction data 258.

Further, the historical GUI interaction data 258 may be used for determining user behavior, pattern of use, and trends. The historical GUI interaction data 258 may also be used for improving user experience and designing more intuitive interfaces. As an end user navigates around the GUI, “queries” may be created on the database 24. The collection of these “queries” over a period of time for the same user or multiple users may correspond to the historical GUI interaction data 258 stored on the database 24. The historical GUI interaction data 258 also be stored in a search history database, or a cache memory after fetching from the databases 24 until the historical GUI interaction data 258 has been processed. Further, the historical GUI interaction data 258 may include an end point for a user session related to the user interaction with the GUI for the at least one location. In an embodiment, the end point for the user session related to the user interaction may be a last destination/ endpoint location searched by a user in the given user session, which may be tracked/stored in the historical GUI interaction data 258. The end point for a GUI session may be determined by the final map rendering displayed to an end user before the exit the GUI application / session or pause on a given map rendering for an extended time (e.g., 1 min, 5 min, etc.) after actively browsing the map GUI.

The AI model 260 may leverage a machine learning (ML) algorithm to analyze geographical data and create optimized clusters based on multiple variables, business rules, and constraints. The AI model 260 may correspond to a clustering model. The clustering model may group / collect geographical points based on a proximity of the geographical points to each other. The geographical points may represent the geographic coordinates (latitude and longitude) of at least one location in the geographical region. Further, the clustering model may group the geographical points that may be geographically close to each other. Here, each group or cluster may indicate a specific geographical region or geographical area. Further, the clustering model may determine a centroid position of the cluster that may be at a center of the cluster. The centroid position of the cluster may further be displayed in an enlarged view on the map UI.

Additionally, the clustering model may include one of a self-supervised learning model, a semi-supervised learning model, or an un-supervised learning model. The self-supervised learning model may be a learning model that may be trained using unlabeled data to make predictions and produce data labels. The self-supervised learning model may generate supervisory signals using structures, relationships, and meaningful patterns present in the input data. Moreover, the self-supervised learning model may be used in navigation systems to produce probable routes. For example, the apparatus 10 may determine probable routes for at least one location in the geographical region, using a self-supervised learning model. Examples of a self-supervised learning model for clustering data may include, but are not limited to, a Self-Labelling (via k-Means) model, a Contrastive Predictive Coding (CPC) model, a Bootstrap Your Own Latent (BYOL) model, a MoCo (Momentum Contrast) model, a Self-Distillation with No Labels model, a Semantic Clustering by Adopting Nearest neighbors (SCAN) model, a Self-Labelling model, a ClusterFit model, or a Prototypical Contrastive Learning (PCL) model.

The semi-supervised learning model may be a learning model that utilizes both labeled and unlabeled data to train the model. The labeled data contains meaningful labels, input-output pair relationships, whereas the unlabeled data may be a raw data with no predefined labels or meaningful tags. The semi-supervised learning model may first learn from the labeled data and then infer patterns in the unlabeled data to classify the unlabeled data. For example, the apparatus 10 may use labeled map data of the geographical region and unlabeled map data of the geographical region. Examples of a semi-supervised learning model for clustering data may include, but are not limited to, a Semi-Supervised k-Means model, Semi-Supervised Gaussian Mixture Models (GMM), a Constrained k-Means model, a Self-Training model, a Co-Training model, a Virtual Adversarial Training (VAT) model, a Pseudo-Labeling model, or a Deep Co-Training model.

The unsupervised learning model may be a learning model that may identify patterns, structures or relationships from unlabeled data. The model may analyze the input data to identify clusters, interesting patterns, or representations to draw conclusions from the unlabeled data. For example, the apparatus 10 may process the map data of the geographical region to group locations into clusters. Examples of a unsupervised learning model for clustering data may include, but are not limited to, a k-Means Clustering model, a Hierarchical Clustering model, a Density-Based Spatial Clustering of Applications with Noise (DBSCAN) model, Gaussian Mixture Models (GMM), a Mean Shift Clustering model, an Agglomerative Clustering model, a Spectral Clustering model, Balanced Iterative Reducing and Clustering using Hierarchies (BIRCH) model, or a Hierarchical Density-Based Spatial Clustering of Applications with Noise (HDBSCAN) model.

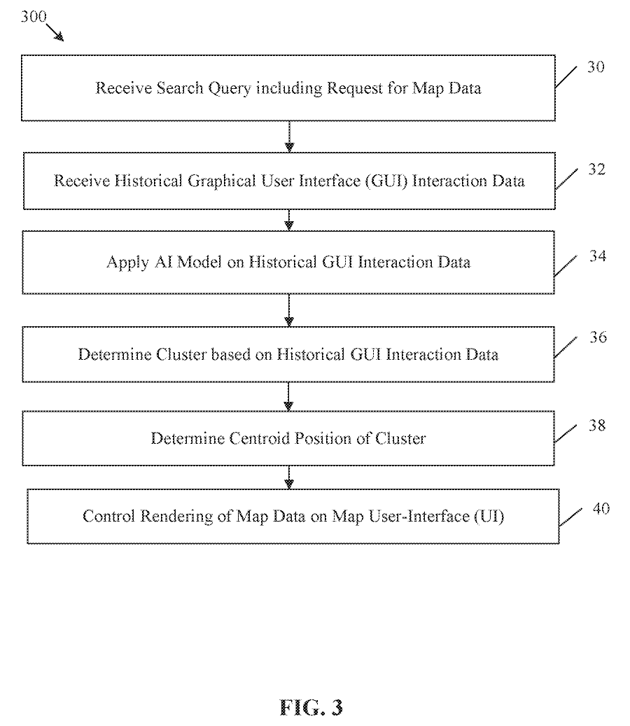

Turning to FIG. 3, the operations performed, such as, by the apparatus 10 of FIG. 1, in order to display map based on location clusters from historical graphical user interface (GUI) interaction data, are described in a flowchart 300. More, fewer, or different acts or steps may be provided in the flowchart 300. At a first step (at block 30), the apparatus 10 may receive a search query including a request for map data of a geographical region. The search query may correspond to a user-input including at least one of, a natural-language text, a natural-language audio, or a user-interaction with the map UI. Herein, the set of users may include the first user (for example, the first user and the second user may be the same person), or in another embodiment, the set of users may exclude the first user (i.e., the first user and the second user may be different). For example, the user-input of the search query may be a map data request, a cluster selection, a user interaction, or the like. Further, the map data of the geographical region may be obtained from various programs, apps, websites, etc., running on said end user device such as location guidance apps (e.g., Google Maps, Here We Go, etc.), satellite, messaging apps, GNSS, GPS, NFC, Wi-Fi triangulation, cellular tower information, micro-mobility data, image data of the end user, radio map data, etc. For example, the search query including the request for map data may be of a national park.

Further, at a second step (at block 32), the apparatus 10 may receive, based on the search query, the historical GUI interaction data 258 related to at least one location in the geographical region. The historical GUI interaction data 258 may include information related to user interaction(s) with a GUI for at least one location. The historical GUI interaction data 258 may be received from any number of users and/or a set of users. Further, the historical GUI interaction data 258 may include a number of user interactions with the GUI for the at least one location. For example, the GUI interaction data may include scrolling, zooming, swiping, etc. inputs from and end user as they navigate the map data presented to them. The map data related to where an end user stops scrolling, etc. may also be accounted for as GUI interaction data. In one example, a map of a national park may be displayed to an end user, and a popular campground may be a common location end users scroll to, zoom in, subsequently search for, etc. once the initial national park map is displayed to the end user(s). The apparatus may track this information and identify one or more trends in the end user GUI usage, keyword searching, or both.

The historical GUI interaction data 258 may be stored in a search history database such as the database 24. In another embodiment, the historical GUI interaction data 258 may include search requests related to a set of locations in the geographical region. For example, the database 24 may be a master map database, such as a high definition (HD) map database, stored in a format that facilitates updates, maintenance, and development. The database 24 may be a master database in which data can be stored in an Oracle spatial format or other spatial format (e.g., accommodating different map layers), such as for development or production purposes.

At a third step (at block 34), the apparatus 10 may apply the AI model 260 on the historical GUI interaction data 258. The AI model 260 may correspond to the clustering model including one of the self-supervised learning model, the semi-supervised learning model, or the un-supervised learning model. For example, the application of the AI model 260 may determine a common routing destinations for the map data of the national park (based on the search queries in the form of end user GUI interactions and/or keyword searching).

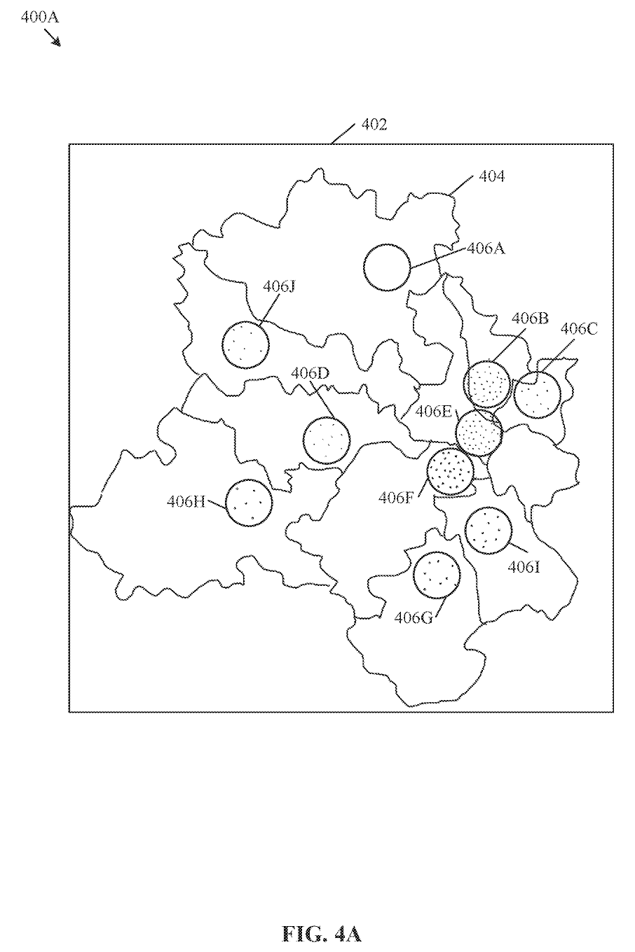

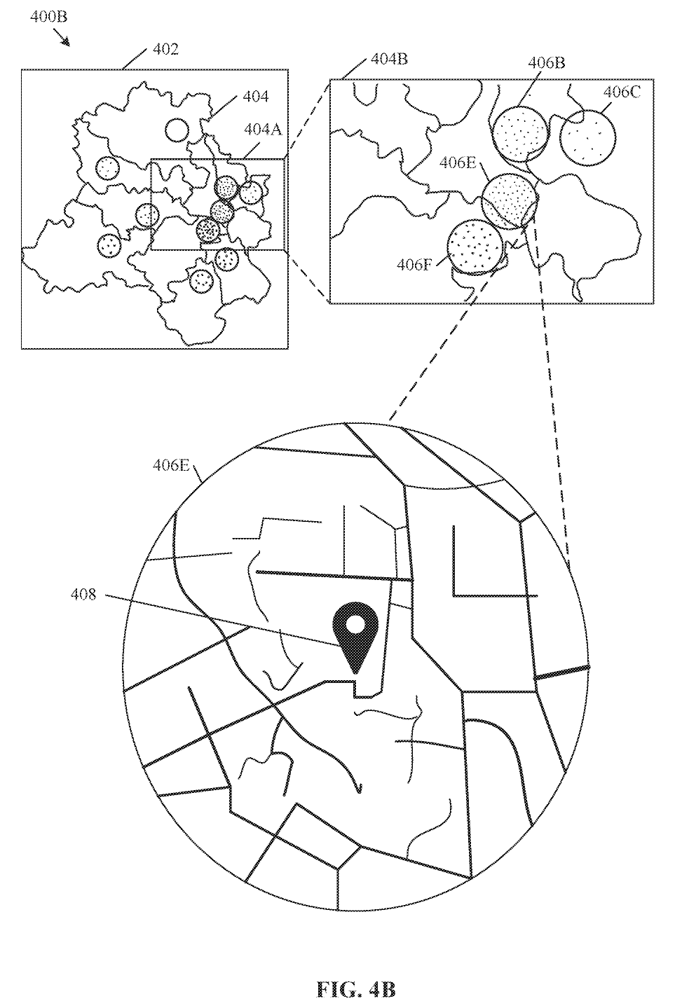

At a fourth step (at block 36), the apparatus 10 may determine the cluster for the at least one location based on the application of the AI model 260 on the historical GUI interaction data 258. The cluster may be determined based at least in part on the number of user interactions included in the historical GUI interaction data 258. Also, the AI model 260 may be used to determine the cluster for the at least one location based on the application of the AI model 260 on the historical GUI interaction data 258. In another embodiment, the apparatus 10 may determine a set of clusters for a set of locations in the geographical region based on historical queries (which may include, for example, textual queries, audio queries, and GUI interaction-based queries). For example, the user interaction may encompass various actions that users perform to engage with the apparatus 10. The various actions on the GUI may include direct manipulation, feedback mechanisms, navigation, input methods, customization, micro interactions, error handling, accessibility features, visual hierarchy, consistency and the likes. For example, the apparatus 10 may determine the cluster to be at the entry gate of the national park (or a restaurant of the national park), based on the population density at the entry (or the restaurant) of the national park. As mentioned above, the end point for an end user session as the scroll through a map of the park, etc. may be used to determine one or more cluster. Such a determination may be made by setting a threshold, for example, if 50% or more of the GUI sessions for a given location end at the same or similar POI, etc. this may be adequate for the apparatus to set this common end point as a default display location (e.g., set the map centroid) at the POI (see FIG. 4B below).

The apparatus 10 may then determine (at block 36) the cluster for the at least one location in the geographical region based on the historical GUI interaction data 258. In an embodiment, the apparatus 10 may select a “winning” cluster from the set of clusters based on the number of user interactions related to the location recorded as the historical GUI interaction data 258 in the database 24. For example, the apparatus 10 may determine the “winning” cluster for the at least one location by determining the size of the cluster, a search-request density of the cluster, and/or the tightness of the cluster. The tightness of the cluster may be determined by identifying the number of user interactions with the GUI for the at least one location associated with the cluster. As used herein, the term “tightness of the cluster” may refer to as how closely related or similar the data points within the cluster may be to each other. In the context of clustering analysis, tightness may be an indicator of the compactness and cohesion of the cluster. A tightly clustered group of data points means that the points are close to each other in terms of a distance metric used (such as Euclidean distance), indicating high similarity among the data points within the cluster. The similarity in the data would be, in some examples, due to the common end user GUI interactions, GUI session end points, etc.

At a fifth step (at block 38), the apparatus 10 may then determine a centroid position of the cluster. The centroid position may be a center of circle associated with the cluster or may be a point that may be high in density inside the cluster. An enlarged view of the at least one location of the cluster may be centered at the centroid position of the cluster on the map UI. The centroid position of the cluster may be the central point that represents the average location of all the data points within the cluster. Also, the centroid position may be a weighted centroid (based on search query hits) of that cluster. For example, the centroid of a cluster may be a weighted center of the cluster based on a density of the number of user interactions (in the historical GUI interaction data 258) related to locations within the cluster. Thus, in this scenario, the centroid of a cluster may be at a location which has the highest density of historical user interactions than the rest of the locations in the cluster.

As mentioned above, the centroid may be set within the cluster of end user data points. In one example, the apparatus may set the centroid at the closest POI or the most popular POI within the cluster. In this example, the centroid position of the cluster may be initially set by factoring in a central point that represents the average (e.g., mean, median, etc.) location of all the data points within the cluster, then examining end user keyword searches, POI metadata, etc. to determine the most likely common destination for end users within the cluster. Once this determination is made, the centroid may be set at this popular POI, geographic feature, etc. for some or all end users searching generally for a park, city, etc.

At a sixth step (block 40), the apparatus 10 may control rendering of the map data on a map UI, based on the at least one location of the cluster. The rendering of the map data may include displaying an indication of the enlarged view of the at least one location of the cluster on the map UI. For example, the apparatus 10 may control rendering of the map data on a map UI to display the visitors center of the national park to the first user.

Turning to FIG. 4A, a scenario diagram 400A of an exemplary map display including a set of clusters discussed above is illustrated. The scenario diagram 400A shows a graphical representation including a map UI 402, a map 404 associated with the search query, and a set of clusters 406. The apparatus 10 may receive the search query including the request for map data of the geographical region. Here, the search query may correspond to a user-input including at least one of natural-language text, natural-language audio, user-interaction with the map UI, or etc. Also, the search query may be received from a first user from a set of users. For example, the request for map data of the geographical region may be “places in Delhi”. In this case, the geographical region may be “Delhi, India” and the map data may include a geographical map of “Delhi”.

The apparatus 10 may then receive, based on the search query, the historical GUI interaction data 258 related to at least one location in the geographical region. The historical GUI interaction data 258 may include information related to a user interaction with a GUI for the at least one location. For example, the historical GUI interaction data 258 may include a number of user interactions with the GUI, and an end point for a user session related to the user interaction with the GUI for the at least one location. In an embodiment, the end point for the user session related to the user interaction may be a last destination/ endpoint location searched by a user in the given user session, which may be tracked/stored in the historical GUI interaction data 258. The historical GUI interaction data 258 may be received from any number of users. The geographical region may include at least one of, but not limited to, a road segment, a building, a monument, a tourist site, an educational campus, a recreational area, an agricultural field, a park, a market area, a shopping complex, a residential area, an office complex, a farmland, a county, a town, a city, a state, or a country. For example, the historical GUI interaction data 258 based on the search query may include most searched locations in “Delhi”, most navigated places in “Delhi”, places with highest foot traffic in “Delhi”, or a popular destination (based on historical search queries) in “Delhi”, etc.

As mentioned above, the high-level map shown in FIG. 4A may be clicked on, scrolled through, zoomed in on, etc. Each of these map manipulations via the use of the GUI may be recorded by the apparatus, each alteration of the map view forming its own search query upon the map database, etc. in some examples.

It is to be noted that, the search query(s) may be stored on the search history database, such as the database 24. Also, the historical GUI interaction data 258 may be received / retrieved from the database 24.

Further, the apparatus 10 may apply the AI model 260 on the historical GUI interaction data 258 to determine the set of clusters 406 (406A – 406I) for the at each location of the set of locations. In another embodiment, the apparatus 10 may determine the set of clusters 406 for the set of locations in the geographical region based on the historical GUI interaction data, and application of AI model 260.

Turning to FIG. 4B, a graphical representation of an exemplary map display indicating a cluster with a highest density (for example, a highest number of historical search queries for the location associated with the cluster) based on historical GUI interaction data 258. As shown in FIG. 4B, a scenario diagram 400B shows the map UI 402, the map 404 associated with the search query, a section 404A of the map 404 associated with the search query, an enlarged view 404B of the section 404A, and the set of clusters 406 with plurality of data points. The data points represented as black dots in this example. The plurality of data points may be graphical representation of population density, foot traffic of the location associated with at least one of the clusters, GUI navigated locations, historical search queries recorded at the location, etc.

The apparatus 10 may determine the cluster (for example, from the set of clusters 406) for the at least one location in the geographical region based on the historical GUI interaction data 258. In an embodiment, the apparatus 10 may select (from the set of clusters 406 of the set of locations), a target cluster of a location from the set of locations based on a number of user interactions with the GUI for the location. In an embodiment, the apparatus 10 may select the cluster of the location based on at least one of the sizes of the cluster, the search-request density of the cluster, tightness of the cluster or etc.

For example, the apparatus 10 may determine a cluster 406E for the location in the geographical region based on the size of the cluster or the search-request density of the cluster being the highest. Here, the cluster 406E may be representing the shopping area of “Old Delhi” according to the search query from a first user, and the historical GUI interaction data 258 from a second user. Herein, the apparatus 10 may determine the cluster 406E (including the shopping area of “Old Delhi”) as the desired location based on the tightness (e.g., lots of data points from GUI interaction and/or keyword searching at or near the same physical location) of the cluster 406E being the highest with respect to the other clusters of the set of clusters 406.

The apparatus 10 may then control rendering of the map data on the map UI 402, based on the at least one location of the cluster 406E. Further, the control of the rendering of the map data corresponds to displaying an indication of an enlarged view of the location of the cluster 406E on the map UI 402. Furthermore, the apparatus 10 may determine a centroid position 408 of the cluster 406E. The centroid position 408 may be the center of circle of the cluster 406E or may be a point that may be high in density of data points, e.g., historical search queries including user interactions (in the historical GUI interaction data 258), inside the cluster 406E. Here, an enlarged view of the location of the cluster 406E may centered at the centroid position 408 of the cluster 406E on the map UI 402. The centroid position 408 of the cluster 406E may be the central point that represents the average location of all the data points within the cluster 406E. Also, the centroid position 408 may be a weighted centroid (based on search query hits) of that cluster 606E. In an example, the centroid position 408 may be a POI such as a top restaurant, famous historical site, or the like, of the cluster 406E that may be located in the general “Old Delhi” area.

It should also be noted in some examples that the apparatus 10, system, etc. may determine the set of clusters with different or same size, also the apparatus 10 may determine or select at least one cluster from the set of clusters 406 based on the tightness of each cluster from the set of clusters 406. Also, it may be noted that the scenarios 400A and 400B of FIGS. 4A and 4B, respectively, are for exemplary purposes and not for limiting the scope of the disclosure.

It will be understood that each node block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 14 of an apparatus 10 employing an embodiment of the present invention and executed by the processing circuit 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method, comprising:
receiving a search query including a request for map data of a geographical region;
receiving, based on the search query, historical graphical user interface (GUI) interaction data related to at least one location in the geographical region;
determining a cluster for the at least one location in the geographical region based on the historical GUI interaction data; and
controlling rendering of the map data on a map user-interface (UI), based on the at least one location of the cluster.

2. The method according to claim 1, wherein
the historical GUI interaction data includes a number of user interactions with the GUI for the at least one location, and
the cluster is determined based at least in part on the number of user interactions included in the historical GUI interaction data.

3. The method according to claim 1, wherein the historical GUI interaction data includes an end point for an end user session related to the user interaction with the GUI for the at least one location.

4. The method according to claim 1, wherein the geographical region includes at least a portion of: a road segment, a building, a monument, a tourist site, an educational campus, a recreational area, an agricultural field, a park, a market area, a shopping complex, a residential area, an office complex, a farm-land, a county, a town, a city, a state, or a country.

5. The method according to claim 1, wherein the search query corresponds to a user-input including at least one of: a natural-language text, a natural-language audio, or a user-interaction with the map UI.

6. The method according to claim 1, wherein the search query is received from a first user and the historical GUI interaction data is received from a second user.

7. The method according to claim 1, further comprising storing the historical GUI interaction data on a database.

8. The method according to claim 1, further comprising:
analyzing via an artificial intelligence (AI) model, the historical GUI interaction data; and
determining the cluster for the at least one location based on an output of the AI model.

9. The method according to claim 1, wherein the controlling the rendering of the map data includes displaying an enlarged view of the location of the cluster on the map UI.

10. The method according to claim 1, further comprising determining a centroid position related to the cluster, wherein an enlarged view of the at least one location of the cluster is centered at the centroid position of the cluster on the map UI.

11. An apparatus, the apparatus comprising at least one processor and at least one memory storing computer program code, the at least one memory and the computer program code configured to, with the processor, cause the apparatus to at least:
receive a search query including a request for map data of a geographical region;
receive, based on the search query, historical graphical user interface (GUI) interaction data related to at least one location in the geographical region;
determine a cluster for the at least one location in the geographical region based on the historical GUI interaction data; and
control rendering of the map data on a map user-interface (UI), based on the at least one location of the cluster.

12. The apparatus according to claim 11, wherein
the historical GUI interaction data includes a number of user interactions with the GUI for the at least one location, and
the cluster is determined based at least in part on the number of user interactions included in the historical GUI interaction data.

13. The apparatus according to claim 14, wherein the historical GUI interaction data includes an end point for an end user session related to the user interaction with the GUI for the at least one location.

14. The apparatus according to claim 13, wherein the at least one memory and the computer program code are further configured to, with the processor, cause the apparatus to at least:
analyze via an artificial intelligence (AI) model, the historical GUI interaction data; and
determine the cluster for the at least one location based on an output of the AI model.

15. The apparatus according to claim 13, wherein the control of the rendering of the map data includes display of an enlarged view of the at least one location of the cluster on the map UI.

16. The apparatus according to claim 11, wherein the at least one memory and the computer program code are further configured to, with the processor, cause the apparatus to at least determine a centroid position related to the cluster, wherein an enlarged view of the at least one location of the cluster is centered at the centroid position of the cluster on the map UI.
